(19) United States
(12) Patent Application Publication
(10) Pub. No.: US 2015/0224673 A1
(43) Pub. Date: Aug. 13, 2015

(54) SLICING DEVICE

(71) Applicant: GREEN ENERGY TECHNOLOGY INC., Taipei (TW)

(72) Inventors: Shih-Min Lin, Kaohsiung City (TW); Shing-Hsiang Wang, Kaohsiung City (TW); Ming-Yi Lin, Kaohsiung City (TW)

(21) Appl. No.: 14/603,365

(22) Filed: Jan. 23, 2015

(30) Foreign Application Priority Data
Feb. 11, 2014 (TW) 103202376

(51) Int. Cl. B28D 5/04; B28D 5/00

(52) U.S. Cl. CPC B28D 5/045; B28D 5/007

(57) ABSTRACT

A slicing device suitable for slicing a workpiece is provided. The slicing device includes at least two rollers and a wire. A slicing passage for the workpiece to pass through is formed between the two rollers. The two rollers are winded by the wire to form a plurality of rings disposed in intervals parallel to each other. When the two rollers rotate to move the rings, the workpiece enters the slicing passage and presses on a portion of the rings spanning the two rollers so that the workpiece is sliced. Each roller has a circular cross-section, and the diameter of the circular cross-section varies along the length direction of each roller, so as to adjust the sizes of the rings.

### CROSS-REFERENCE TO RELATED APPLICATION

This application claims the priority benefit of Taiwan application serial no. 103202376, filed on Feb. 11, 2014. The entirety of the above-mentioned patent application is hereby incorporated by reference herein and made a part of this specification.

### BACKGROUND OF THE INVENTION

1. Field of the Invention

The invention relates to a cutting device, and particularly relates to a slicing device.

2. Description of Related Art

Along with mans increasing awareness for green energy, there is a developing demand for solar cells, where solar cells of silicon have again developed into the mainstream. In the manufacturing process of silicon solar cells, the first silicon material with a certain purity is melted and then later crystallized to form a silicon ingot, and then the silicon ingot is sliced into a plurality of wafers.

The slicing process may be performed by using a slicing device. Typically, slicing devices have a wire with a certain in-line tension wound around a periphery of a plurality of rollers foiming a plurality of rings. A portion of the rings will span between the rollers, and the rings are driven when the rollers are turned. Then, the silicon ingot is pressed on a portion of the rings that spans the rollers to achieve a goal of cutting the silicon ingot.

Under ideal conditions, the in-line tension is the tension of the individual rings. However, after being pressed by the silicon ingot, the rings may be stretched, or the wire diameter of the rings may change due to wear between the silicon ingots. All the factors mentioned above will cause the tension of individual rings to be different from the in-line tension. In a situation where the tensions of the rings are inconsistent, a problem where the sliced wafers having uneven thicknesses and such that poor quality of sliced parts may occur.

### SUMMARY OF THE INVENTION

The invention provides a slicing device having the good slicing quality.

A slicing device of the invention is suitable for slicing a workpiece. The slicing device includes at least two rollers and a wire. A slicing passage for the workpiece to pass through is formed between the two rollers. The wire is wounded on the two rollers to foim a plurality of rings disposed in intervals parallel to each other. When the at least two rollers rotate to move the rings, the workpiece enters the slicing passage and presses on a portion of the rings spanning the slicing passage so that the workpiece is sliced. Each roller has a circular cross section, and a diameter of the circular cross sections of each roller varies along the length direction of each roller so as to adjust the sizes of the rings.

In an embodiment of the invention, the diameter of the circular cross sections of each roller increases along the length direction of each roller.

In an embodiment of the invention, each roller has a circular top surface and a circular bottom surface, and a diameter of the circular bottom surface is larger than a diameter of the circular top surface. In regards to the at least two rollers, the circular top surfaces are justified with each other, and the circular bottom surfaces are justified with each other.

In an embodiment of the invention, the wire has an in-line segment and an out-line segment. The in-line segment connects to one of the rings which is closest to the circular top surface, and the out-line segment connects to one of the rings which is closest to the circular bottom surface.

In an embodiment of the invention, the diameter of the circular cross sections of each roller has a linear relationship with the length of each roller.

In an embodiment of the invention, the slicing device further includes a fixing component and a grout spraying device. The fixing component is disposed above the slicing passage in an arrangement that allows translational movement, for fixing the workpiece. When the at least two rollers rotate and move the rings, the fixing component translationally displaces the workpiece so that the workpiece enters the slicing passage. The grout spraying device is disposed at a side of the fixing component, for spraying polishing slurry to the rings.

Based on the above, in the slicing device of the invention, the size of the diameter of the circular cross section of the roller varies along the length direction, whereby the sizes of the plurality of rings formed by the wire winded on the rollers may be adjusted, and then the tension of each ring may be adjusted and allowing the tension of each ring to approach a certain value, for example a predetermined in-line tension value. Accordingly, the slicing device may provide good slicing quality under the stable tension conditions.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a three dimensional schematic view illustrating a slicing device according to an embodiment of the invention.

FIG. 2 is a schematic plan view of the slicing device of FIG. 1.

FIG. 3 is a schematic side view of the roller of FIG. 1.

FIG. 4 is a three dimensional schematic view illustrating a slicing device according to another embodiment of the invention.

FIG. 5 is a three dimensional schematic view illustrating a slicing device according to another embodiment of the invention.

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

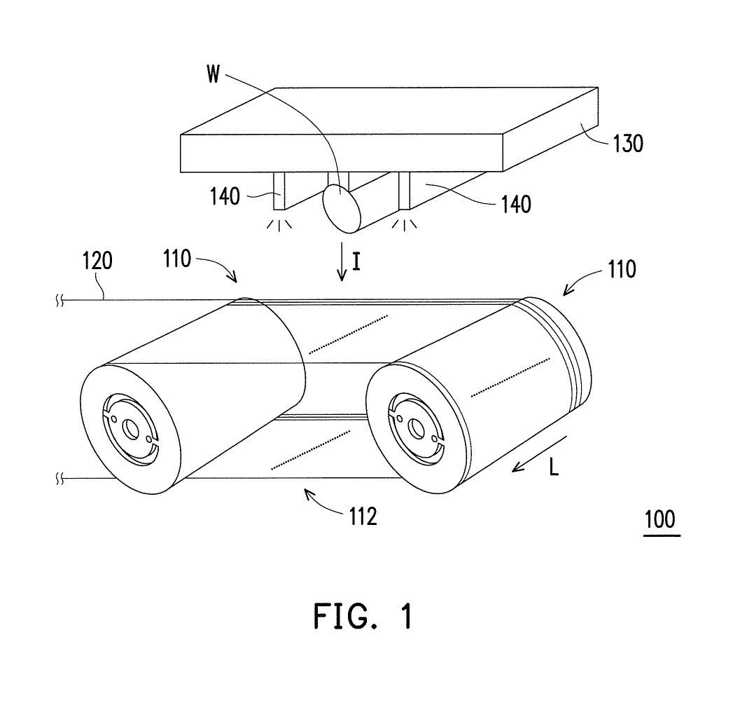

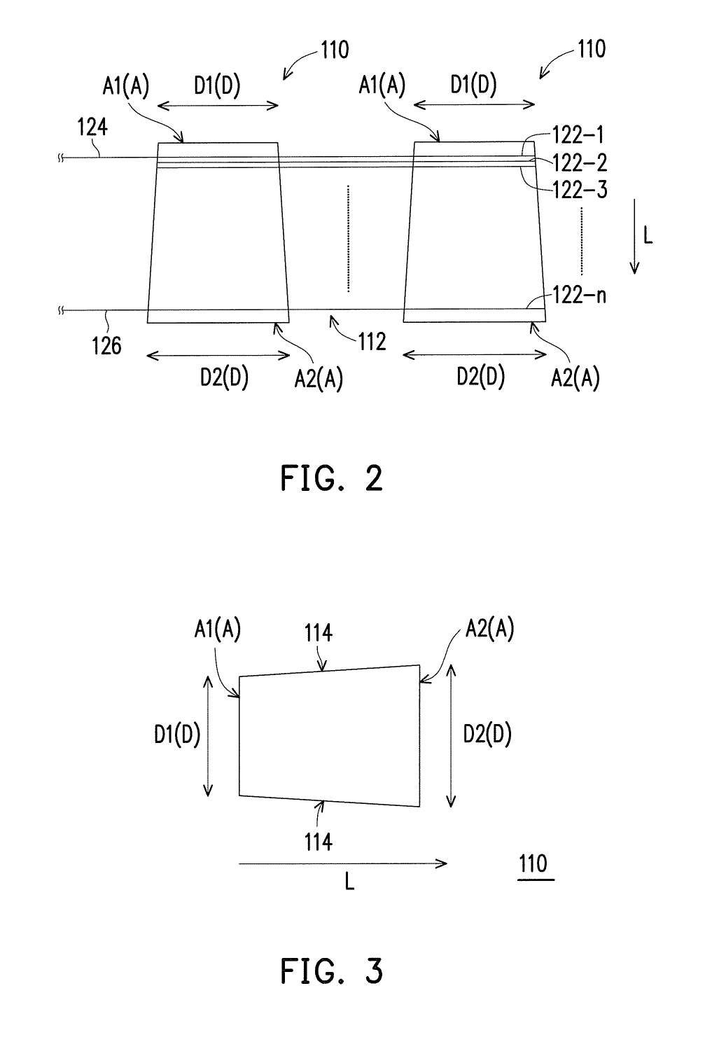

FIG. 1 is a three dimensional schematic view illustrating a slicing device according to an embodiment of the invention. FIG. 2 is a schematic plan view of the slicing device of FIG. 1. To make the schematic clearer, the schematic plan view of FIG. 2 has partial components omitted. Referring to FIG. 1 and FIG. 2, a slicing device 100 is used for slicing a workpiece W. The slicing device 100 of the present embodiment, for example, is a boule slicing device, and the workpiece W, for example, is a cylindrical silicon ingot or other columnar shaped silicon ingot.

The slicing device 100 includes two rollers 110 separated by some distance, a wire 120, a fixing component 130 and two grout spraying devices 140. A slicing passage 112 for the workpiece W to pass through is formed between the two rollers 110, and the two rollers 110 are winded by the wire 120 to form a plurality of rings 122-1, 122-2, 122-3, . . . , 122-n disposed in intervals parallel to each other. The fixing component 130 may be disposed above the slicing passage 112 in an arrangement that allows translational movement, and is used to fix the workpiece W. The two grout spraying devices 140 are disposed on sides of the fixing component 130, and is used to spray a polishing slurry on the rings 122-1, 122-2, 122-3, . . . , 122-n.

When the two rollers 110 rotate and move the rings 122-1, 122-2, 122-3, . . . , 122-n, for example, by a motor driver, the fixing component 130 translationally displaces the workpiece W along a feed direction I so that the workpiece W enters the slicing passage 112. Here the workpiece W presses a portion of the rings 122 spanning the slicing passage 112, and the grout spraying device 140 sprays a polishing slurry which attaches on the rings 122-1, 122-2, 122-3, . . . , 122-n, and is moved together by the rollers 110. Therefore, the polishing slurry will rub the workpiece W and will slice the workpiece W with the rings 122-1, 122-2, 122-3, . . . , 122-n. Whereby, the workpiece W may be sliced into a plurality of sheets.

It should be noted, the present embodiment has two rollers 110 having similar shapes, sizes and lengths as an example for explanation purposes, and the length direction L shows the length direction of the two rollers, wherein the length direction L is perpendicular to the feed direction I. Also, N is one of any positive integers, and the number of rings should not be construed as a limitation to the invention.

As shown in FIG. 1 and FIG. 2, each roller 110 has a circular cross section A, and a diameter D of the circular cross section A of each roller 110 varies along the length direction L of each roller 110, so as to adjust the size of the rings 122. In the present embodiment, each of the rings 122-1, 122-2, 122-3, . . . , 122-n winds around the periphery of the two rollers 110 sequentially along the length direction L, therefore the size of the diameter D of the circular cross section A will influence the size of each of the rings 122-1, 122-2, 122-3, . . . , 122-n. Furthermore, the wire 120 winds around the two rollers 110 with a fixed length, therefore the sizes of the rings 122-1, 122-2, 122-3, . . . , 122-n influence the tension of the rings. For example, a larger ring 122-n has a higher tension, and a smaller ring 122-1 has a lower tension. In the present embodiment, the tension of each of the rings 122-1, 122-2, 122-3, . . . , 122-n is adjusted by adjusting the sizes of the rings 122-1, 122-2, 122-3, . . . , 122-n, which are formed by the wire 120, to compensate for the varying tension conditions of the rings, which is caused by the wear or pressure resulted from the workpiece W. Therefore, the tension of the rings 122-1, 122-2, 122-3, . . . , 122-n may be made to approach a certain value, for example a predeteii lined in-line tension value, so as to further improve the slicing quality of the slicing device 100.

In the present embodiment, the diameter D of the circular cross section A of each roller 110 is changed from small to big along the length direction L. Therefore, the size of each of the rings 122-1, 122-2, 122-3, . . . , 122-n increases along the length direction L of the roller 110, which is making the tension of the rings 122-1, 122-2, 122-3, . . . , 122-n increase along the length direction L. Furthermore, each roller 110 has a circular top surface A1 and a circular bottom surface A2, in which the diameter D2 of the circular bottom surface A2 is greater than the diameter D1 of the circular top surface A1. In regards to the two rollers 110, the circular top surfaces are justified with each other, and the circular bottom surfaces are justified with each other that allows the circular top surfaces A1 to be located at one side of the slicing device 100 and allows the circular bottom surfaces A2 to be located respectively on another side of the slicing device 100. More specifically, in the present embodiment, the wire 120 has an in-line segment 124 and an out-line segment 126. The in-line segment 124 connects to one of the rings 122-1, 122-2, 122-3, . . . , 122-n, which is closest to the circular top surface A1, namely ring 121-1 in the figure. The out-line segment 126 connects to one of the rings 122-1, 122-2, 122-3, . . . , 122-n, which is closest to the circular bottom surface A2, namely ring 122-n in the figure. The in-line segment 124, for example, may connect again to an in-line roller (not shown), and the out-line segment 126, for example, may connect again to an out-line roller (not shown). Therefore, the tension of the rings 122-1, 122-2, 122-3, . . . , 122-n increases from the in-line location towards the out-line location.

FIG. 3 is a schematic side view of the roller of FIG. 1. Referring to FIG. 3, more specifically, in the present embodiment, the diameter D of the circular cross section A of each roller 110 have a linear relationship with the length of each roller 110, and the roller 110 is a conical cylinder. As shown in FIG. 3, the side surface of the roller 110 includes two tapered lines 114. The change in the diameter D of the circular cross section A of the roller 110 along the length direction L may be adjusted by adjusting the sizes of the circular top surface A1 and the circular bottom surface A2. For example, it may be adjusting the difference of the circular top surface A1 and the circular bottom surface A2, and may be adjusting the gradient of the tapered lines 114. Whereby, the diameter D may be adjusted to a suitable size according to the tension conditions needed to be compensated by the slicing device 100. For example, when the predetermined in-line tension of the slicing device 100 is 22N, following from the previously mentioned linear relationship, the difference between the diameter D1 of the circular top surface A1 and the diameter D2 of the circular bottom surface A2 may be made to be 0.5 mm. Whereby, the tension of the rings 122-1, 122-2, 122-3, . . . , 122-n may be made to be between 22N to 23.5N. Otherwise, when the predetermined in-line tension of the slicing device 100 is 22N, following from the previously mentioned linear relationship, the difference between the diameter D1 of the circular top surface A1 and the diameter D2 of the circular bottom surface A2 may be made to be 2 mm. Therefore, the tension of the rings 122-1, 122-2, 122-3, . . . , 122-n may be made to be between 17.5N to 22N.

Obviously, the invention does not limit the relationship between the diameters D of the circular cross sections of the rollers and the lengths of the rollers 110 to be linear. For example, in other embodiments, the roller may be divided into a plurality of sections along the length direction, the circular cross sections of a section having the same diameter size, and the circular cross section between each section having different diameter sizes, so the diameter of the circular cross sections present in segmented variations.

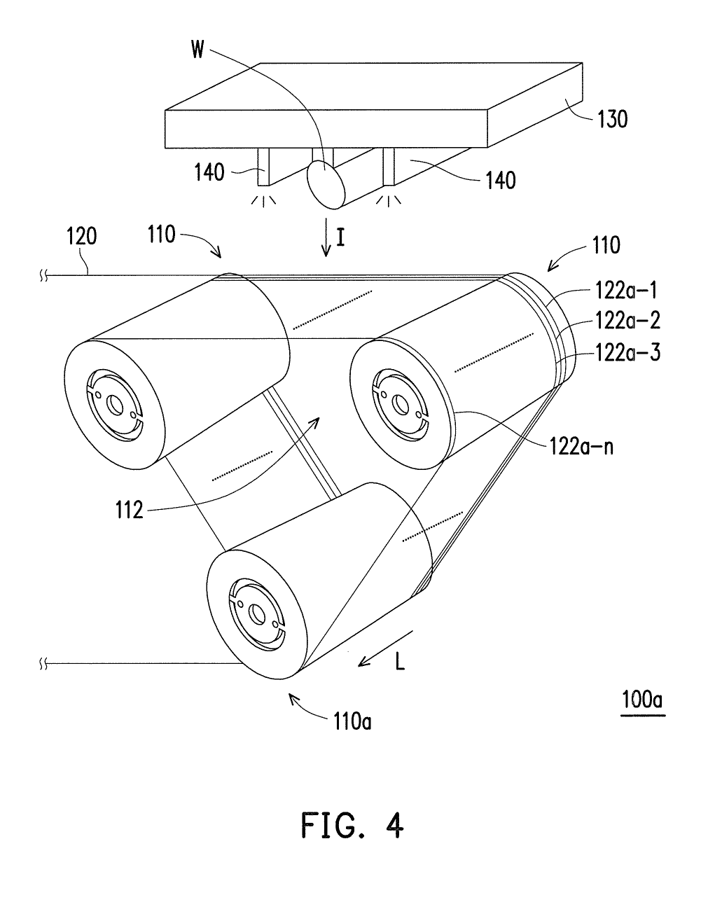

In the below embodiments, the same reference numbers and a portion of the contents from the previous embodiment are used, wherein the same reference numbers are used to represent same or like parts, and description of similar technical content will be omitted. Regarding the description of the omitted portions, reference may be made to the previous embodiment, and will not be repeated in the below embodiment. FIG. 4 is a three dimensional schematic view illustrating a slicing device according to another embodiment of the invention. The embodiment of FIG. 4 is similar to the embodiment of FIG. 1, the main difference of the two lies in, the slicing device 100a of the present embodiment includes a third roller 110a. The rollers 110 and 100a are disposed presenting a triangular shape. Three of the rollers 110 and 110a are winded by the wire 120 to form a plurality of rings 122a-1, 122a-2, 122a-3, . . . , 122a-n, which are disposed in intervals parallel to each other. The present embodiment has rollers 110 and 110a having similar shapes, sizes and lengths as an example for explanation purposes, and the length direction L shows the length direction of the three. In the present embodiment, the diameter of the circular cross section of each of the rollers 110 and 110a changes along the length direction L, and adjusts the sizes of the rings 122a-1, 122a-2, 122a-3, . . . , 122a-n. Whereby, the tension of each of the rings 122a-1, 122a-2, 122a-3, . . . , 122a-n may be adjusted, so as to further improve the slicing quality of the slicing device 100a.

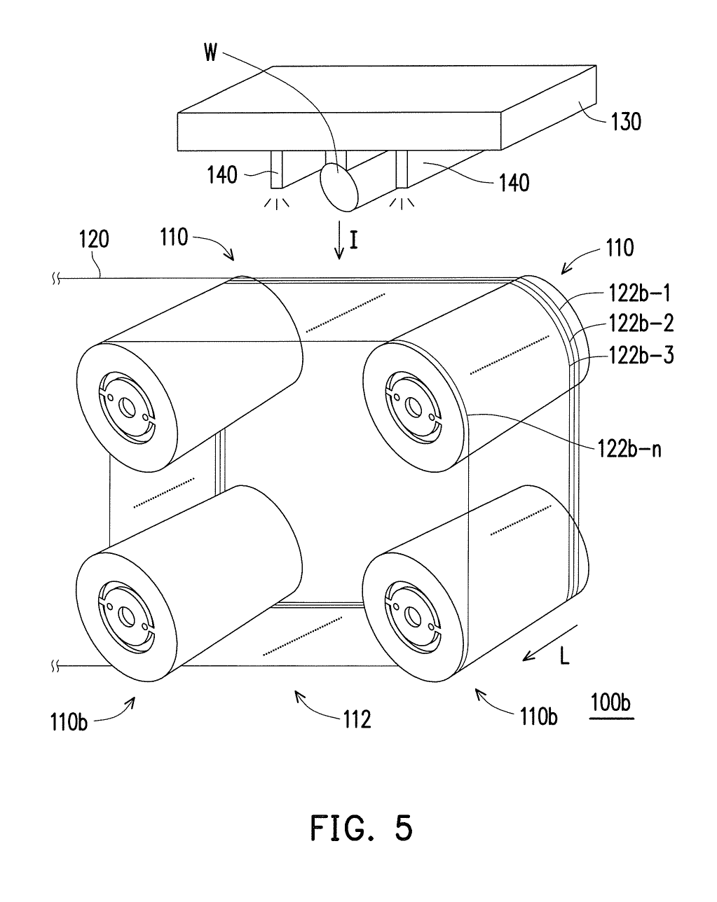

FIG. 5 is a three dimensional schematic view illustrating a slicing device according to another embodiment of the invention. The slicing device 100b of the present embodiment further includes two rollers 110b. Four rollers 110 and 110b are disposed presenting a rectangular shape. The four rollers 110 and 110b are winded by the wire 120 to form a plurality of rings 122b-1, 122b-2, 122b-3, . . . , 122b-n, which are disposed in intervals parallel to each other. Similar to the previous embodiment, the present embodiment has rollers 110 and 110b having similar shapes, sizes and lengths as an example for explanation purposes, and the length direction L shows the length direction of the four. The diameter of the circular cross section of each of the rollers 110 and 110b varies along the length direction L and adjusts the sizes of the rings 122b-1, 122b-2, 122b-3, . . . , 122b-n so as to further improve the slicing quality of the slicing device 100a. The description regarding this aspect may be referred to previous embodiment and will not be repeated here. It should be noted, the number of rollers should not be construed as a limitation to the invention. The number of rollers and the arrangement method may be suitably adjusted according to the slicing conditions needed by the slicing device.

In summary, in the slicing device of the invention, the size of the diameter of the circular cross section of the roller changes along the length direction. Therefore, the size of the plurality of rings, which is formed by winding wire on the periphery of the two rollers, may be adjusted. The tensions of the rings are adjusted by adjusting the sizes of the rings to allow the tension of each ring to approach a certain value, for example a predetermined in-line tension value. Accordingly, the slicing device may provide good slicing quality under the stable tension conditions.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A slicing device suitable for slicing a workpiece, the slicing device comprising:
at least two rollers, wherein a slicing passage for the workpiece to pass through is formed between the at least two rollers; and
a wire, wounded on to the at least two rollers to form a plurality of rings disposed in intervals parallel to each other, and when the at least two rollers rotating to move the rings, the workpiece entering the slicing passage and pressing on a portion of the rings spanning the slicing passage so that the workpiece is sliced,
wherein each roller has a circular cross section, and a diameter of the circular cross sections of each roller varies along a length direction of each roller so as to adjust the sizes of the rings.

2. The slicing device as claimed in claim 1, wherein the diameter of the circular cross sections of each roller increases along the length direction of each roller.

3. The slicing device as claimed in claim 1, wherein each roller has a circular top surface and a circular bottom surface, a diameter of the circular bottom surface is larger than a diameter of the circular top surface, in regards to the at least two rollers, the circular top surfaces are justified with each other, and the circular bottom surfaces are justified with each other.

4. The slicing device as claimed in claim 3, wherein the wire has an in-line segment and an out-line segment, the in-line segment connects to one of the rings which is closest to the circular top surface, and the out-line segment connects to one of the rings which is closest to the circular bottom surface.

5. The slicing device as claimed in claim 1, wherein the diameter of the circular cross sections of each roller has a linear relationship with a length of each roller.

6. The slicing device as claimed in claim 1, further comprising:
a fixing component, disposed above the slicing passage in an arrangement that allows translational movement, for fixing the workpiece, wherein when the at least two rollers rotate and move the rings, the fixing component translationally displaces the workpiece so that the workpiece enters the slicing passage; and
a grout spraying device, disposed at a side of the fixing component, for spraying polishing slurry to the rings.
